(19) United States
(12) Patent Application Publication
(10) Pub. No.: US 2002/0152759 A1
(43) Pub. Date: Oct. 24, 2002

(54) System manifold for integrated delivery of refrigerant and leak detection dye, and methods of delivering leak detection dye

(76) Inventors: Jack Brass, North York (CA); Jeffrey W. Socket, Downsview (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/840,231

(22) Filed: Apr. 24, 2001

(51) Int. Cl. C02F 1/22; B01D 9/04; F25B 45/00

(52) U.S. Cl. 62/124; 62/292

(57) ABSTRACT

A method, system and manifold for use in the delivery of refrigerant and leak detection dye to an automotive air conditioning unit after evacuation of the unit and without removal of the manifold from a fitting of the unit between delivery of the dye and the refrigerant, and without requirement by the operator to refill the dye between each delivery of dye and refrigerant. The refrigerant and dye come from separate, not inline, reservoirs. The refrigerant provides a wash for dye from the fitting. The method, system and manifold are substantially automated and are operated with limited operator intervention.

### FIELD OF THE INVENTION

The invention relates to devices and methods for delivering leak detection dye into air conditioning units.

### BACKGROUND OF THE INVENTION

The conventional method of identifying leaks in air conditioning units comprises filling an injector with dye, attaching the injector to the air conditioning unit, injecting the dye into the unit, removing the injector and filling the next unit. All steps are operator performed. The unit is then pressurized and an ultraviolet light is shone on the outside of the unit. If there is a leak then the dye should seep through the unit and fluoresce under the light. Numerous patents describe this process including U.S. Pat. No. 6,177,678 issued Jan. 23, 2001 to Brass et al, under title Method and Apparatus for Leak Detection and Non-Destructive Testing; and number U.S. Pat. No. 5,804,822 issued Sep. 8, 1998 to Brass et al, under title Fault Locating Device, System and Method.

An example of an inline injector for this purpose is shown in U.S. Pat. No. 5,673,722 issued to Jack Brass on Oct. 7, 1997. A refrigerant source is attached to the filled injector and used to propel the dye into the air conditioning unit. In order to fill the next unit the injector is removed and manually refilled.

An example of a multiuse injector is shown in U.S. co-pending patent application Ser. No. 09/185,814 of Brass et al having the same assignee as this application and filed Nov. 3, 1998 under title Precision Liquid Injection System. This injector contains sufficient quantity of dye for multiple injections. It is filled and attached to the unit. The dye is then delivered using manual pressure to force the dye into the air conditioning unit. The injector is then removed from the unit in order to fill the next unit. If the unit is to also be filled with refrigerant then this must be done in separately.

These injection methods have some drawbacks. As an example, dye can remain on the outside of a fitting on the air conditioning unit where the dye is introduced into the unit. As well, dye can drip from the injector after the injector is removed from the unit. The drips may land on the unit being filled or on another unit. This can lead to false indications of a leak or hide the existence of an actual leak.

An alternative method is to deliver the dye in the form of a tablet into an air conditioning component, such as an accumulator, prior to assembly of the air conditioning unit. When refrigerant or other liquids are later delivered to the unit, the tablet dissolves and the dye goes into solution. This method is described in U.S. reissue Pat. No. Re. 36,951 issued Nov. 14, 2000 to Cooper et al under title Method of Introducing Leak Detection Dye into an Air Conditioning or Refrigeration System Including Solid or Semi-Solid Fluorescent Dyes.

Further alternative methods continue to be desirable. It is an object of the invention to provide such alternative methods, and devices to implement such methods.

### SUMMARY OF THE INVENTION

In a first aspect the invention provides a method of delivering leak detection dye into an air conditioning unit having a fitting for receiving fluids. The method includes the following steps. A source of refrigerant is connected to a first inlet port of a manifold. A source of dye is connected to a second inlet port of the manifold. An outlet port of the manifold is connected to the fitting. A quantity of dye is delivered from the source of dye through the first inlet port, the outlet port and the fitting to the unit. A quantity of refrigerant is then delivered from the source of refrigerant through the second inlet port, the outlet port and the fitting to the unit.

The manifold may have a third inlet port and a source of vacuum pressure is connected to the third inlet port. Prior to delivering the dye, the vacuum source applies a vacuum to the air conditioning unit through the outlet port. The vacuum source is fluidly disconnected from the air conditioning unit prior to delivery of the dye.

The vacuum remains in the air conditioning unit after fluid disconnection of the vacuum source.

The fitting may have a valve that is opened for fluid delivery by depressing a pin. In this case, the manifold may have a fourth inlet port. A stem air source of pressurized air is connected to the fourth inlet port, and the outlet port has a stem that actuates on application of the stem air pressurized air from the fourth inlet port. The stem depresses the pin to open the valve prior to application of the vacuum by the vacuum source, delivery of the dye and delivery of the refrigerant.

The manifold may have a fifth inlet port and a seal mechanism that actuates on application of pressurized air. A seal pressure source of pressurized air is connected to the fifth inlet port. The sealing mechanism is placed about the fitting. Prior to actuating the stem, the sealing mechanism is actuated by applying seal pressure pressurized air through the fifth inlet port to clamp and seal the manifold to the fitting about the outlet port.

The manifold may have a control valve to open and close fluid connection between the first inlet port and the outlet port. The control valve may be actuated through the application and removal of pressurized air. A sixth inlet port may be connected to a selection source of pressurized air.

The manifold may have a plurality of valves to permit and prevent fluid connection between the first, second and third inlet ports and the outlet port.

In a second aspect the invention provides a method for use in the delivery of refrigerant and leak detection dye to an air conditioning unit. The method includes the following steps. The unit is evacuated. Then leak detection dye is delivered to the evacuated unit from a first source through a delivery mechanism connected to the unit. Refrigerant is then delivered from a second source separate from the first source. The refrigerant is delivered to the evacuated air conditioning unit through the same delivery mechanism as the dye, without removing the delivery mechanism from the air conditioning unit between the delivery of the dye and the delivery of the refrigerant.

In a third aspect the invention provides a method for use in the delivery of refrigerant and leak detection dye to an air conditioning unit. The method includes the following steps. The unit is evacuated. Then leak detection dye is delivered to the evacuated unit from a first source through a delivery mechanism connected to the unit. Then refrigerant is delivered from a second source not inline with the first source to the evacuated air conditioning unit through the same delivery mechanism without removing the delivery mechanism from the air conditioning unit between the delivery of the dye and the delivery of the refrigerant.

In a fourth aspect the invention provides a method for use in the delivery of leak detection dye to an air conditioning unit. The method includes the following steps. The unit is evacuated. Leak detection dye is delivered to the evacuated unit from a first source through a delivery mechanism connected to a fitting of the unit. The dye is then washed from the fitting on the air conditioning unit by delivering refrigerant from a second source separate from the first source to the evacuated air conditioning unit through the same delivery mechanism without removing the delivery mechanism from the air conditioning unit between the delivery of the dye and the delivery of the refrigerant.

In a fifth aspect the invention provides a method for use in the delivery of leak detection dye to an air conditioning unit. The method includes the following steps. The unit is evacuated. Then dye is delivered to the evacuated unit from a first source through a delivery mechanism connected to the unit and refrigerant is delivered from a second source separate from the first source to the evacuated air conditioning unit through the same delivery mechanism.

The step of washing the delivery mechanism may wash all areas of the delivery mechanism that come into contact with dye during delivery and are open to the atmosphere when the delivery mechanism is removed from the fitting.

The methods in each aspect of the invention can have dye and refrigerant sources that multiuse capacity. The capacity may be sufficient for at least one plant shift.

In a sixth aspect the invention provides a method of delivering refrigerant and dye to an air conditioning unit having a fitting. The method includes the following steps.

First dye is delivered from one source. Subsequent to delivering the dye, refrigerant is delivered from another source. Both the dye and refrigerant are delivered through the fitting without removal between the delivery of the dye and the delivery of the refrigerant of any delivery mechanism connected to the fitting.

The air conditioning unit may be evacuated prior to delivery of the dye and refrigerant. The dye reservoir may be manually carriable. The dye may be pumped from a dye reservoir.

Any one-way valve in the fitting may be opened prior to evacuating the system and delivering the dye and refrigerant. The valve may be closed following delivery of the refrigerant. The delivery mechanism may be removably connected to the fitting prior to opening the one-way valve in the fitting. The delivery mechanism may be disconnected from the fitting after the one-way valve is closed. The one-way valve may be opened by extending a stem into the fitting from the delivery mechanism. The one-way valve may be closed by retracting the stem from the fitting.

The delivery mechanism may be connected to the fitting by sealing about the fitting. The delivery mechanism may be disconnected by unsealing the delivery mechanism from the fitting.

Each of the methods may be carried out without operator intervention. The step of delivering the dye to the unit may use metering of the amount of dye prior to the dye entering the unit. The dye may be metered by filling a chamber of known quantity prior to the dye entering the unit. The chamber may be evacuated prior to filling the chamber with dye. As part of delivering dye, the dye may be propelled from the chamber into the unit using the refrigerant.

In a seventh aspect the invention provides a manifold for use in the delivery of leak detection dye to an air conditioning unit. The manifold includes an inlet port for fluid connection to a refrigerant source, an inlet port for fluid connection to a dye source separate from the refrigerant source, and an outlet port for the delivery of the dye and refrigerant from the manifold.

The manifold may have an inlet port for connection to a vacuum source, and a select control port for opening and closing a fluid connection between the vacuum source and the outlet port. The manifold may have valves to prevent fluid connection between the inlet port of the refrigerant and the inlet port of the dye. The manifold may have valves to prevent fluid connection between the inlet port for the refrigerant, the inlet port for the dye and the inlet port for the vacuum. The manifold may be an integrated unit.

The manifold may have a chamber connected to the inlet port for fluid connection to the dye source. The chamber meters the dye from the dye source as the dye is delivered through the manifold. The chamber may also be connected to the inlet port for fluid connection to the refrigerant source for propelling the dye from the chamber to the outlet port using refrigerant.

The manifold may also have a first valve inline between the inlet port for fluid connection to a dye source and the chamber, a second valve inline between the inlet port for fluid connection to a refrigerant source and the chamber, and a third valve inline between the outlet port and the chamber and inlet ports.

The first valve may open when dye is delivered into the manifold while the second and third valves are closed, the first valve may close when the chamber is full of dye, the second and third valves may open when refrigerant is delivered to the manifold.

The chamber may also be connected to the inlet port for connection to a vacuum source. The select control port opens and closes fluid connection between the vacuum source and the chamber. The manifold may have a fourth valve inline between the vacuum source and the chamber and outlet port. The fourth valve and the third valve may open when the select control port opens the fluid connection at the outlet port, while the first and second valves are closed.

In an eighth aspect the invention provides a system for the delivery of leak detection dye to an air conditioning unit. The system includes a refrigerant source, a dye source separate from the refrigerant source, a manifold. The manifold includes an inlet port for fluid connection to a refrigerant source, an inlet port for fluid connection to a dye source separate from the refrigerant source, and an outlet port for the delivery of the dye and refrigerant from the manifold. The system also includes a control unit for activating the dye source to deliver dye to the outlet port and then activating the refrigerant source to deliver dye to the outlet port.

The system may include a vacuum source; in which case, the control unit fluidly connects the vacuum source to the outlet prior to delivery of the dye and refrigerant to create a vacuum into which the dye and refrigerant are delivered.

The system may include a select source; in which case, the manifold may further include a control port for receiving the select source and the manifold fluidly connects and disconnects the vacuum source from the outlet depending on whether the select source is activated or deactivated. The select source is activated and deactivated by the control unit.

The system may have a seal source; in which case, the outlet port may have a seal mechanism that seals the outlet port to and releases the outlet port from the air conditioning unit depending on whether or not the seal source is activated or deactivated. The seal source is activated or deactivated by the control unit.

The dye source may have a dye reservoir for containing multiuse quantity of dye. The dye source may have a manually carriable dye reservoir for containing dye. The dye reservoir may have sufficient capacity for at least a plant shift. The dye source may also have a first pressurizing pump to deliver the dye from the dye reservoir to the outlet port.

The refrigerant source may have a bulk reservoir. The refrigerant source may have a second pressurizing pump to deliver the refrigerant from the refrigerant reservoir to the outlet port.

In a ninth aspect the invention provides a system for the delivery of leak detection dye to an air conditioning unit. The system includes a refrigerant source having a bulk refrigerant reservoir, a dye source having a bulk refrigerant reservoir separate from the refrigerant source, and a manifold. The manifold may have an inlet port for fluid connection to a refrigerant source, an inlet port for fluid connection to a dye source separate from the refrigerant source, and an outlet port for the delivery of the dye and refrigerant from the manifold. The system also has a control unit for activating the dye source to deliver dye to the outlet port and activating the refrigerant source to deliver dye to the outlet port.

The system may have any of the manifolds described previously.

In each of the aspects, the dye may be a liquid, powder, slurry or tablet dye or carried on a substrate. Powder, slurry, and tablet dyes and those carried on a substrate may be dissolved in the delivery process prior to entering the air conditioning unit. They may be dissolved in refrigerant in the chamber.

### BRIEF DESCRIPTION OF THE DRAWINGS

For a better understanding of the present invention and to show more clearly how it may be carried into effect, reference will now be made, by way of example, to the accompanying drawings which show the preferred embodiment of the present invention and in which:

FIG. 1 is a block diagram of a refrigerant and dye delivery system and manifold according to the preferred embodiment of the invention;

FIG. 2 is a block diagram of a leak detection dye source used in the system of FIG. 1;

FIG. 3 is a block diagram of a refrigerant source used in the system of FIG. 1;

FIG. 4 is a block diagram of the system of FIG. 1 operating in accordance with the preferred embodiment of the method of the invention showing activation of a seal source to activate a seal mechanism about an air conditioning fitting external to the system;

FIG. 5 is a block diagram of the system of FIG. 1 operating in accordance with the preferred embodiment of the method of the invention showing activation of a stem source and a select source, fluid connection of a vacuum source, and activation of the vacuum source;

FIG. 6 is a block diagram of the system of FIG. 1 operating in accordance with the preferred embodiment of the method of the invention showing deactivation of the vacuum source;

FIG. 7 is a block diagram of the system of FIG. 1 operating in accordance with the preferred embodiment of the method of the invention showing activation of a dye source;

FIG. 8 is a block diagram of the system of FIG. 1 operating in accordance with the preferred embodiment of the method of the invention showing activation of a refrigerant source;

FIG. 9 is a block diagram of the system of FIG. 1 operating in accordance with the preferred embodiment of the method of the invention showing deactivation of the stem source;

FIG. 10 is a block diagram of the system of FIG. 1 operating in accordance with the preferred embodiment of the method of the invention showing deactivation of the seal source and removal of the system from the fitting;

FIG. 11 is a block diagram of a chamber and valve configuration for the manifold of FIG. 1; and

FIG. 12 is a block diagram of an alternate embodiment of a refrigeration and dye delivery system.

### DETAILED DESCRIPTION OF THE PREFERRED EMBODIMENT

In its broadest aspects, the preferred embodiments illustrate a method of delivering refrigerant and leak detection dye to an air conditioning unit by delivering the dye from one source and delivering the refrigerant from another source. The dye and refrigerant are delivered through the same fitting on the air conditioning unit. The source of dye is external to, and not inline with, the source of refrigerant. The method operates in conjunction with a delivery mechanism, such as a system or manifold. The delivery mechanism is not removed from the fitting between delivery of the dye and the refrigerant. Optimally, the dye is delivered first and followed by the refrigerant. Optimally, the refrigerant traverses any delivery path of the dye that is open to the atmosphere at the time the delivery mechanism is removed from the fitting. Optimally, the source of dye contains sufficient dye to fill multiple air conditioning units.

The term “fitting” is used throughout this description; however, it is recognized that air conditioning units generally have multiple fittings that access areas into which dye and refrigerant are held. Thus, the term “fitting”, including “fitting 31” as later used, includes applications where access to the unit for refrigerant and dye filling purposes is through single or multiple fittings, normally the “high side” and/or “low side” fittings of the air conditioning unit.

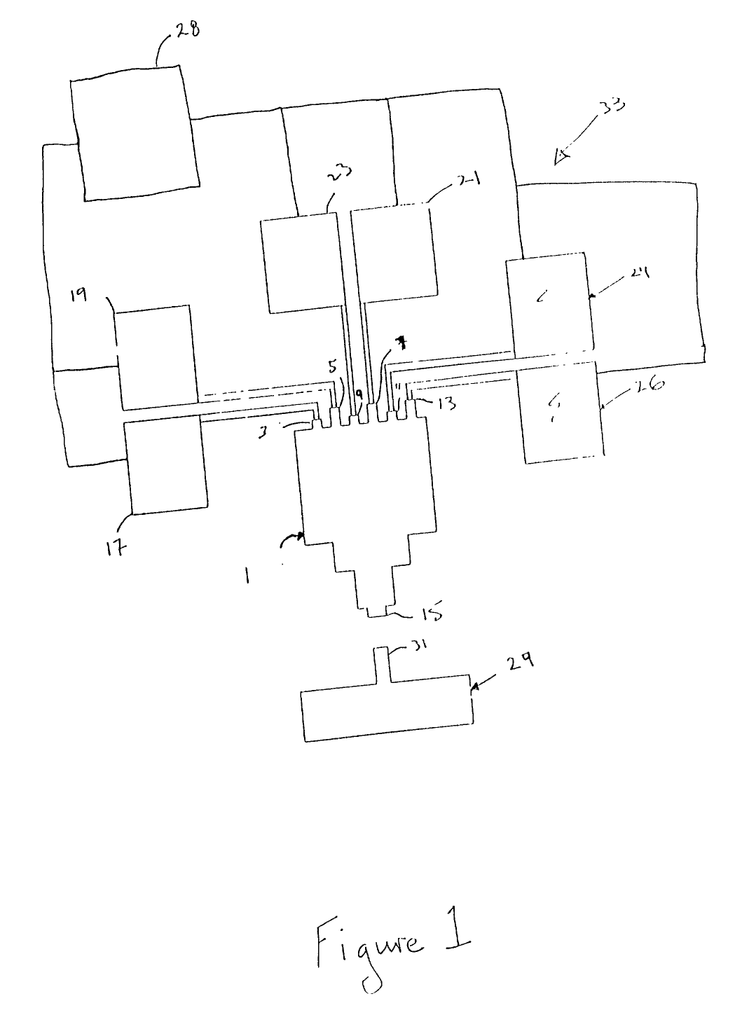

Referring to FIG. 1, a manifold 1 has three control ports 3, 5, 7, three inlet ports 9, 11, 13 and one outlet port 15. Control ports 3, 5, 7 are connected to respective seal, select and stem pressurized air sources 17, 19, 21. Inlet port 9 is connected to a vacuum source 23. Inlet port 11 is connected to a refrigerant source 24. Inlet port 13 is connected to a leak detection dye source 26. The sources 17, 19, 21, 23, 24 and 26 are each connected to and controlled by a control unit 28 to provide the functionality described herein. The control unit 28 may be any means of control, such as a personal computer and software, or a dedicated hardwired proprietary control means. In the preferred embodiment a programmable logic array was used to balance various design parameters, such as cost, size and ease of programming.

The manifold 1 is used to fill an air conditioning unit 29 having a fitting 31. The manifold 1 and the sources 17, 19, 21, 23, 24, 26 and control unit 28 together form a refrigerant and dye delivery system 33. The fitting 31 usually contains a Schraeder or similar one-way valve, not shown, that is opened by actuating an externally accessible spring loaded pin.

The exact pressure and timing of each step in the refrigerant and dye fill method will depend on the particular configuration chosen by the designer. To the extent that this description refers to particular timing, it is assumed that a configuration is used that is similar to manifolds, not shown, currently used in the industry. The principles contained in this description are not restricted to any particular configuration of timing and pressure referred to in this description.

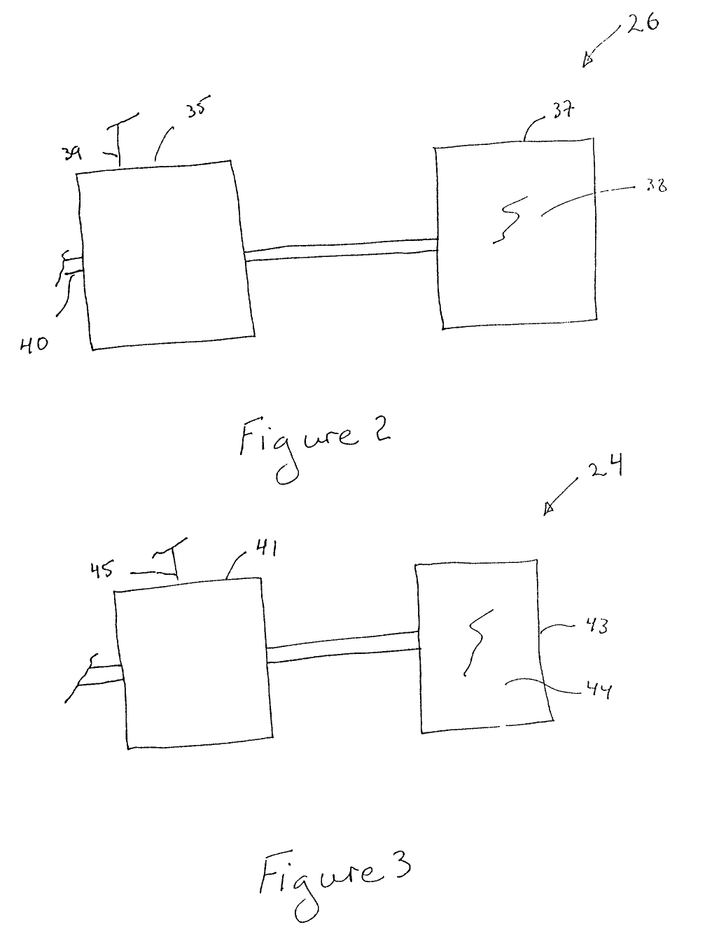

The manifold 1 can be created by modifying the design of existing refrigerant delivery manifolds, not shown, such as Semi-Automatic Charging Tool for HFC 134A, PCU Model 13200 sold by PCU Inc. facsimile number 937-297-7192 U.S.A. to allow for the additional functionality described herein. Referring to FIG. 2, the dye source 26 may be made up of a pressurizing pump 35 and a dye reservoir 37. Dye 38 is held within the reservoir 37.

The control unit 28 is connected to the source 26 at a control input 39 of the pressurizing pump 35. The dye source 26 is activated by the control unit 28 turning on the pressurizing pump 35 to force dye 38 from the reservoir 37 to the manifold 1 through outlet port 40 of the pressurizing pump 35.

The dye 38 used in the preferred embodiment is a liquid dye, for example a parylene dye, such as the 90000 Series dye sold by Cliplight Manufacturing, Toronto, Canada; however, other liquid leak detection dyes and formulations would be suitable depending on the type and amount of refrigerant used in the air conditioning unit. As will be discussed later, the method, system 33 and manifold 1 may be applied to non-liquid dye sources 26 with consequent modifications.

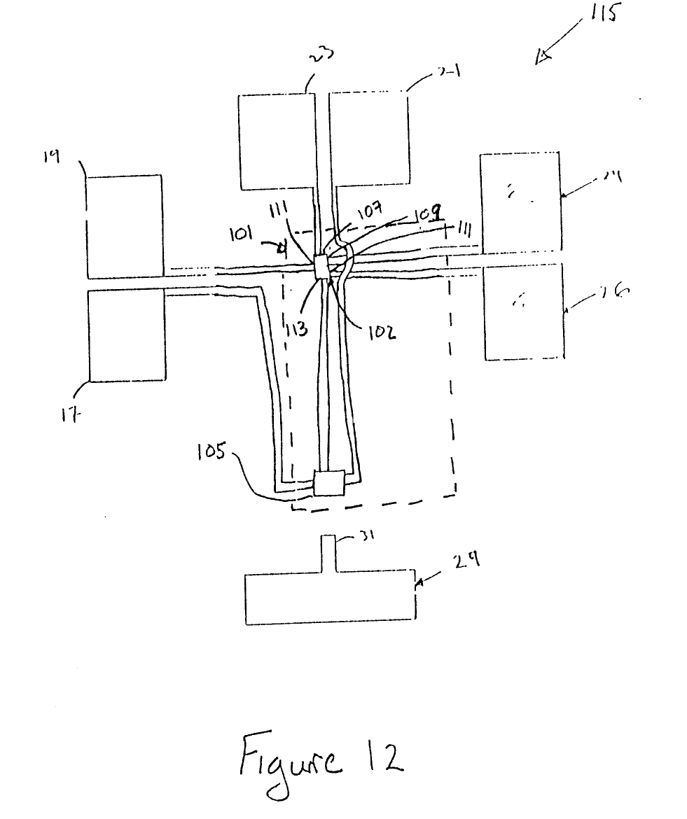

Pressurizing pump 35 can force the dye 38 into the manifold 1 at sufficient pressure to overcome any check valves between the dye reservoir 37 and the outlet port 15. In this case, the dye must be metered before entering the manifold 1 by or after the dye source 26. Alternately, as described later with respect to FIG. 11, the dye 38 may be metered by the manifold 1.

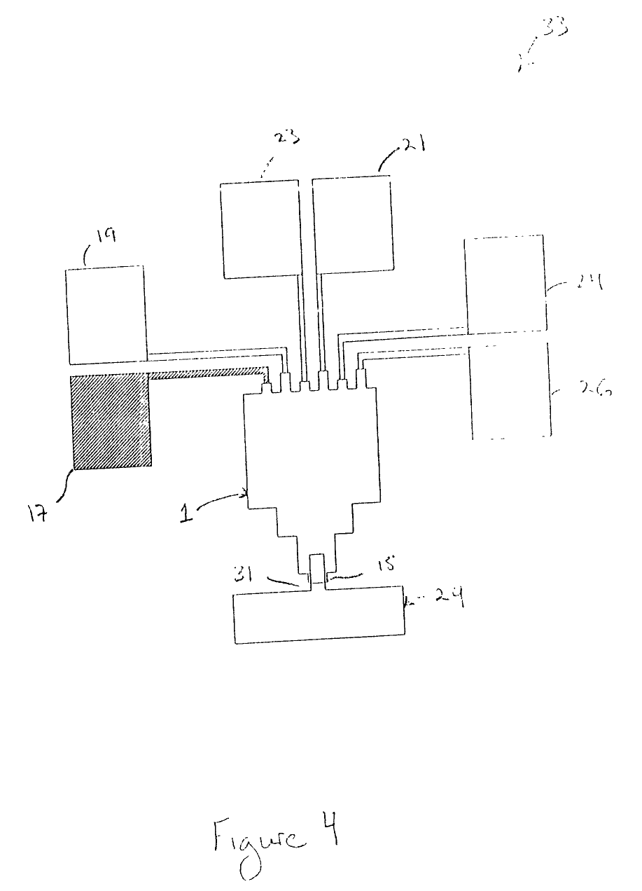

Referring to FIG. 3, the refrigerant source 24 has a pressurizing pump 41 and a refrigerant reservoir 43. Refrigerant 44 is contained within the reservoir 43. The control unit 28 is connected to the refrigerant source 24 at a control input 45 of the pressurizing pump 41. The refrigerant source 24 is activated by the control unit 28 turning on the pressurizing pump 41 to force the refrigerant 44 from the container 43 to the manifold 1 through outlet port 47 of the pressurizing pump 41.

The refrigerant used in the preferred embodiment is R134A. Obviously, other refrigerants can be used depending on the specifications of the air conditioning unit and applicable regulations. Other additives may be injected into the air conditioning system such as refrigerant oil, provided that all the materials to be contained in the air conditioning unit 29 are compatible with one another.

Again, the particular configurations described in FIGS. 2 and 3 for the sources 26, 24 are examples only. It will be evident to persons skilled in the art that other configurations are possible while remaining within the scope of the invention as later claimed.

The refrigerant reservoir 43 will preferably be large and may be located above the air conditioning unit 29, for example near the ceiling in an automotive assembly plant application. This provides additional gravity pressure to the refrigerant 44, reducing the load on the pumps 35, 41. It also conserves space on the plant floor.

The dye reservoir 37 need not be physically large. In typical concentrations one litre of dye is sufficient for approximately eight hundred automotive car air conditioning units. This size of reservoir could be changed or refilled on a plant shift or multiple shift basis. The actual size of the dye reservoir 37 will be chosen according to the requirements of a particular installation. Larger or smaller reservoirs 37 will also be useful. The dye reservoir can be located near or remote from the operator. Locating the reservoir near the operator allows for refill or replacement by the operator without significant affect on other assembly operations. The size of the reservoir 37 may be determined by such factors as rules applicable to particular installations regarding the size of container that may be carried by the operator of the system.

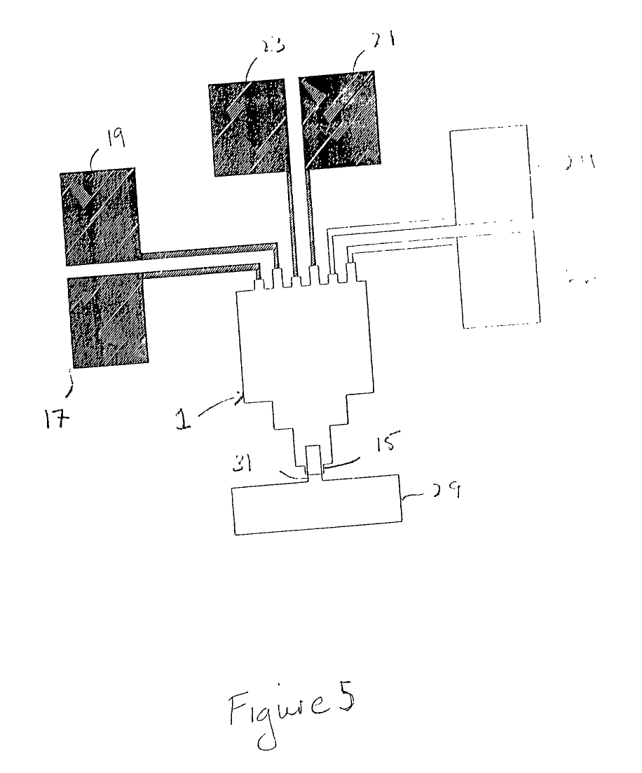

In FIGS. 4 through 11 the control unit 28 has been omitted for ease of understanding the Figures; however, it will be understood that the control unit 28 continues to control the system 33 and later described system 115.

Preferably the manifold 1 swings down over the unit and is located about the fitting 31. The location of the manifold 1 may be performed by an operator or may be performed using robots or other automated means. The manifold 1 can be made to move with the air conditioning unit in moving assembly line installations. Other elements of the system 33 may move with the manifold 1 or the elements may be connected to the manifold 1 by means that allow for movement of the manifold 1.

Referring to FIG. 4, in operation, the outlet port 15 contains a sealing mechanism, not shown, such as those used in existing manifolds referred to previously, to seal the outlet port 15 about the fitting 31 on activation of the seal source 17. In initial design embodiments of the refrigerant and dye fill method, the sealing process is allotted 5 seconds.

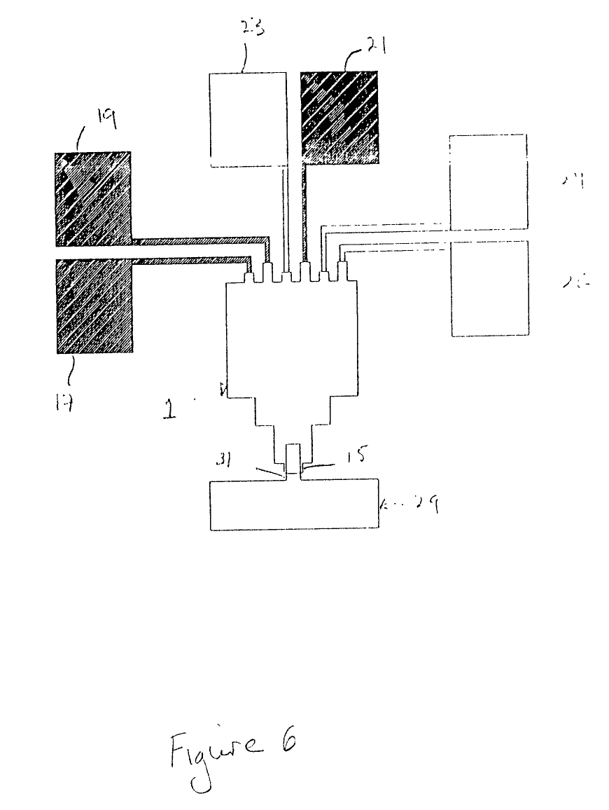

Referring to FIG. 5, once the outlet port 15 is sealed to the fitting 31, the stem source 21 is activated to provide pressurized air to cause a stem, not shown, to extend through, while not completely blocking, the outlet port 15. This actuates the pin in the fitting 31 and opens the one-way valve in the fitting 31. The select source 19 is activated to provide fluid connection between the vacuum source 23 and the outlet port 15. This delivers a vacuum to the air conditioning unit 29 through the outlet port 15. In other words, the air conditioning unit 29 is evacuated by the source 23. Evacuating unit 29 removes substances that can decrease the effectiveness of the unit 29 and which could be dangerous, such as air containing water vapour. Evacuation also provides space for the later delivery of dye 38 and refrigerant 44. In the initial design embodiment of the refrigerant and dye fill method, this step is allotted 45 seconds.

The manifold 1 contains a series of valves (an example of which is later described with reference to FIG.11) to ensure that the vacuum does not draw refrigerant 44 or dye 38 from the sources 24, 26. It is possible that the valves could be left out of the manifold 1 or modified if the sources 24, 26 can perform similar functions or other valves are provided outside the manifold 1.

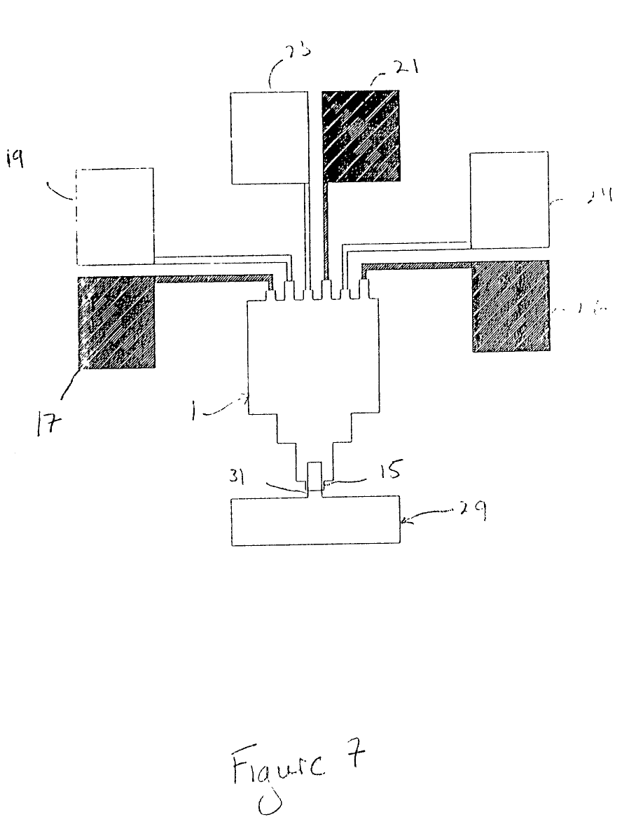

Referring to FIG. 6, the select source 19 is deactivated to disconnect the vacuum source 23 from the outlet port 15. A period of time is allotted to test if the vacuum decays. In the initial design embodiment of the refrigerant and dye fill method, the vacuum decay test step is allotted 15 seconds. If the vacuum test fails then the refrigerant and dye fill method is stopped, the manifold 1 is removed from the fitting 31, and the air conditioning unit is taken offline for leak detection and repair. Typical vacuums in the automotive industry are up to 29 inches; however, other vacuum ratings may be employed as appropriate for the particular installation.

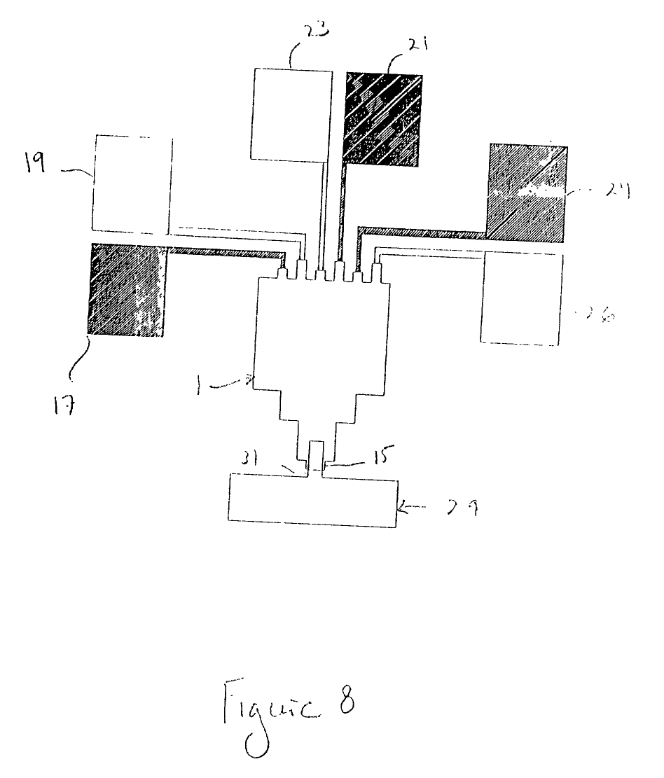

Referring to FIG. 7, following successful of the vacuum decay test, the dye source 26 is activated as described previously to deliver dye 38 through the manifold 1 to the air conditioning unit 29. In the initial design embodiment of the refrigerant and dye fill method, the alternate embodiment described with reference to FIG. 11 is used and the dye delivery into the later described chamber 50 is allotted 2 seconds.

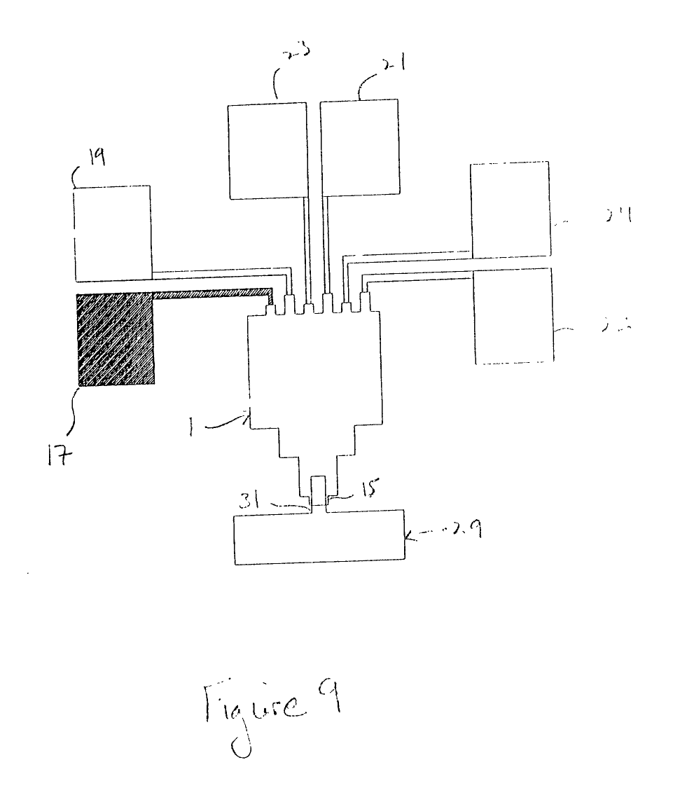

Referring to FIG. 8, the dye source 26 is deactivated and the refrigerant source 24 is activated. This delivers a desired quantity of refrigerant 44 to the air conditioning unit 29. In the initial design embodiment of the refrigerant and dye fill method the refrigerant delivery step is allotted 20 seconds.

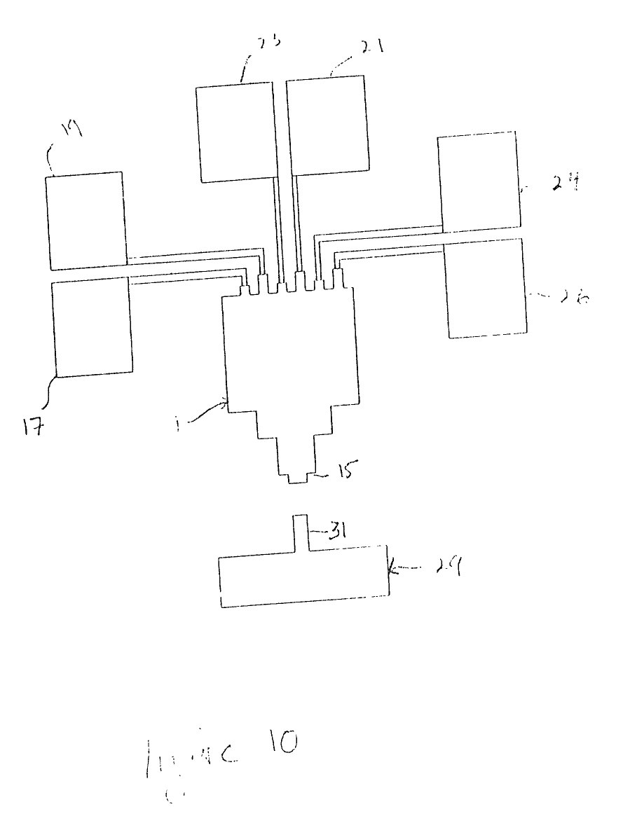

Referring to FIG. 9, the stem source 21 is then deactivated. This retracts the stem at the outlet port 15 and allows the one-way valve in the fitting 31 to close.

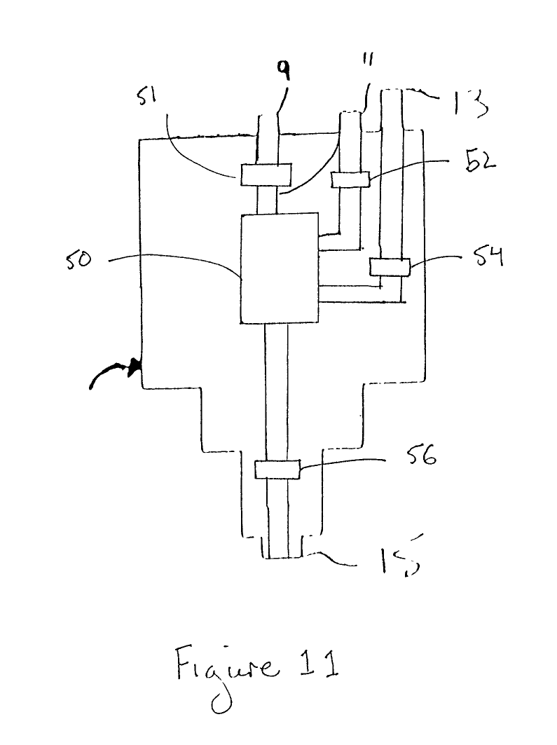

Referring to FIG. 10, the seal source is then deactivated releasing the seal mechanism at the outlet port 15 from the fitting 31.

The manifold 1 is then separated from the fitting 31.

As will be evident to those skilled in the art, the system 33 is particularly useful to original equipment assemblers having high volumes of air conditioning units that require delivery of dye and refrigerant. Automotive assemblers would be an example. However, it may also be useful to those in the aftermarket that have sufficient refill volume. The existing refrigerant could be removed as part of the refrigerant and dye fill method. This would most effectively be performed at the evacuation step.

For those that want the benefit of using different reservoirs 37 and 43 that are separately refillable and can hold large quantities of dye 38 and refrigerant 44, and do not require the benefit of the refrigerant wash, the method and the system 33 can be used to deliver the dye after the refrigerant or the refrigerant and dye at the same time. Care should be taken to ensure that delivery of the refrigerant and dye at the same time does not cause crossflow or backwash of refrigerant or dye into the sources 24, 26.

Referring to FIG. 11, in order to meter the amount of dye delivered to the unit 29, to limit parts of the manifold 1 that come into contact with dye 38 and are open to the atmosphere when the delivery mechanism is disconnected from the fitting 31, and to effectively wash those parts with refrigerant, the manifold 1 may be configured to contain a chamber 50, control valve 51 and check valves 52, 54, 56. Other elements of the manifold 1 have been omitted from FIG. 11 for clarity. Control valve 51 is connected inline between chamber 50 and inlet port 9. Check valve 52 is connected inline between the chamber 50 and inlet port 11, check valve 54 is connected inline between the chamber 50 and inlet port 13, and check valve 56 is connected inline between the chamber 50 and the outlet port 15.

Preferably, the chamber 50 is sized to provide the amount of dye 38 required for a single air conditioning unit 29 fill operation. It is possible provide a chamber that is resizable if alternate amounts of dye 38 are required. Alternatively, the concentration of the dye 38 could be changed for a particular specification of air conditioning unit 29. In a further (although less desirable) alternative, certain steps of the method could be repeated to meter multiple quantities of dye 38 through the chamber 50.

In operation, all valves 51, 52, 54, 56 are initially closed. During the vacuum step previously described with reference to FIG. 5, the select source 19 opens control valve 41. The draw from vacuum source 23 causes a pressure differential sufficient to open check valve 46. Vacuum source 23 evacuates the unit 29. As part of the evacuation step, any refrigerant 44 in the chamber 50 may be removed and recycled. Control valve 41 is closed by the select source 19 when the unit 29 is sufficiently evacuated. As fluid flow from the unit 29 to the vacuum source 23 diminishes, check valve 46 closes. This maintains separate vacuums in chamber 50 and unit 29.

The vacuum test is performed on the unit 29 as discussed with reference to FIG. 6. Following the vacuum test, dye 38 is delivered from the source 26. The pressure from the dye source 26 is sufficient to overcome the check valve 54 and the dye 38 fills the chamber 50. The pressure from the source 26 is not sufficient to open the other check valves 42, 46. When the chamber 50 is filled with dye 38, the dye source 26 ceases to deliver dye and the check valve 54 closes.

The refrigerant 54 is then delivered by the refrigerant source 24 with sufficient pressure to open valve 52 and to open valve 56. This causes the dye 38 to be propelled into the unit 29 followed by the refrigerant 54.

The amount of refrigerant 44 may be metered by the source 24 or the refrigerant source 24 may be deactivated when the unit 29 is full. When pressure is no longer applied by the refrigerant source 24, check valves 52, 56 close.

The stem source 21 is deactivated as previously described with reference to FIG. 9. The seal source 17 is deactivated as previously described with reference to FIG. 10. The manifold 1 is then removed from the fitting 31 and ready to fill the next unit 29. For fill operations, the operator is not required to perform any additional steps to those currently performed in many installations to fill refrigerant alone. Between fill operations, it need only be ensured that the refrigerant and dye reservoirs 37 and 43 have sufficient quantities of refrigerant 44 and dye 38, respectively. With multiple use reservoirs sized appropriately for a particular installation, this need not be a time consuming task. For example, at the start of a shift an operator could fill or replace the dye reservoir 37 with sufficient quantity of dye for the shift. In an automated installation, the control unit 28 can be implemented to monitor the levels of refrigerant 44 and dye 38.

The embodiment of FIG. 11 is described with reference to check valves 52, 54, 56 that operate in response to pressures within the manifold 1. It will be evident to those skilled in the art that other configurations fall within the spirit and scope for the invention, such as those that are externally controlled by pressure or electrical means. As a further example, the valve 56 could be opened and closed by the stem source 21, moving in conjunction with the stem. This may result in multiple extension and retraction operations of the stem that may not be desirable in a particular application.

There will inevitably be some mixing of the refrigerant 44 and dye 38; however, there is substantially more refrigerant 44 than dye 38. As a result the refrigerant 44 will wash dye 38 from those areas of the manifold 1 that come into contact with the refrigerant 44. In particular, the area between the valve 56 and the outlet port 15 is washed. This limits the possibility that dye 38 will remain on the fitting 31 or drip from the manifold 1 after the manifold 1 is removed from the fitting 31.

For additional protection, it may be desirable to configure the chamber 50 and connections back to the valve 54 to allow the refrigerant to come into contact with areas of the manifold 1 that the dye 38 contacts.

The fill method may be carried out in an entirely automated manner. The control unit 28 may control all functions of the system 33 once the unit is located about the fitting 31. The control unit 28 may interface with or form part of the system, not shown, that controls the locating of the manifold 1. Alternatively, the control unit 28 may have an interface for uperator input, such as a “start” switch. When the manifold 1 is located about the fitting 31 and an “end” switch when the manifold 1 is to be removed from the fitting 31. The control unit 28 may also be configured to receive operator input at other steps in the method.

Accordingly, the fill method can be seamless in an automotive or other production environment. It is useful in fixed assembly stations and on a moving assembly line.

The method, system 33 and manifold 1 can be adapted to deliver the dye in forms other than a liquid. For example, the dye 38 could be delivered as a slurry having some solid particles, or as powder or tablet or carried on a substrate each of which are soluble in refrigerant 44. A slurry dye 38 could be delivered in the same manner as a liquid dye 38. If required to move through the fitting 29, the slurry dye 38 can be additionally dissolved in the chamber 50 with refrigerant 44. A powder dye 38 could be delivered by blowing it into chamber 50 and/or unit 29. The powder dye 38 could be dissolved by the refrigerant 44 in the chamber 50 or later when it enters the unit 29. A tablet or substrate dye 38 could be manually or automatically dispensed into the chamber 50 and dissolved in the chamber 50 by refrigerant 44 in order to pass through the fitting 31.

Alternative embodiments employing the refrigerant and dye fill method are possible. Referring to FIG. 12, such an alternative embodiment is shown. Similar elements from the previous embodiment will be referenced with like reference numerals and there description may not be repeated.

A non-integrated manifold 101 has a control valve 102 and an outlet fitting 105. The control valve 102 has first, second and third inlet ports 107, 109, 110 a control port 111 and an outlet port 113. The first inlet port 107 is connected to the vacuum source 23, the second inlet port 109 is connected to the refrigeration source 24 and the third inlet port 110 is connected to the dye source 26. The control port 111 is connected to the select source 19. The outlet port 113 is connected to the outlet fitting 105. Also connected to the outlet fitting 105 are the seal source 17 and the stem source 21.

The manifold 101 and the sources 17,19, 21, 23, 24, 26 and the control unit 28 together form a refrigerant and dye delivery system 115.

The operation of the non-integrated manifold is very similar to the integrated manifold 1. The outlet fitting 105 is placed about the air conditioning unit 29 fitting 31.

The outlet fitting 105 is sealed to the fitting 31 on activation of the seal source 17.

The pin of the fitting 31 is actuated by a stem in the outlet fitting 105 upon activation of the source 21.

Upon activation of the select source 19, the control valve 102 places the vacuum source 23 in fluid connection with the outlet fitting 105. A vacuum is placed on the air conditioning unit 29, followed by a vacuum decay test.

The vacuum source 23 is taken out of fluid disconnection with the outlet fitting 105 by deactivating the select source 19 and closing the control valve 102. The dye source 26 is activated to deliver a quantity of dye 27 to the air conditioning unit 29. The refrigerant source 24 is then activated to deliver a quantity of refrigerant 25 to the air conditioning unit 29.

The stem source 21 is deactivated to close the fitting 31. The seal source 17 is deactivated to release the outlet fitting 105.

The control valve 102 may contain a chamber 50 and check valve 52, 54, 56 to provide metering as described for manifold 1.

It is evident that the integrated and non-integrated manifolds 1, 101 and the methods under which they are utilized provide very similar functionality and utilize very similar principles in their broadest aspects. The embodiments described in this description are provided for illustration of the general nature of the broadest aspects of the invention and are not limiting to those broadest aspects.

Although the manifolds 1, 101 have been described with the use of pneumatic controls for the select, stem and seal functions, it will be evident to those skilled in the art, that these functions could be driven by alternate means, such as electrically controlled solenoids that provide the necessary motive force, or other alternate means of providing similar functions.

The methods, systems and devices described herein, in their various aspects and to varying degrees, can have numerous advantages. For example, the delivery of dye and refrigerant through the same fitting 31 on the air conditioning unit 29 without removal of the delivery mechanism (outlet port 15 in the case of manifold 1 and the outlet fitting 105 in the case of manifold 101) from the fitting 31 between delivery of the dye and delivery of the refrigerant provides a wash of the dye from the fitting 31 and the manifolds 1, 101 by the refrigerant and does not allow dye to leak out of the manifolds 1, 101 when the delivery mechanism is removed from the fitting 31.

Using a non-inline source 26 of dye 38 allows the source 26 to be easily monitored and replenished on a volume basis. It is not necessary to replenish the source 26 with dye 38 between each delivery of dye 38.

It will be understood by those skilled in the art that this description is made with reference to the preferred embodiment and that it is possible to make other embodiments employing the principles of the invention which fall within its spirit and scope as defined by the following claims.

We claim:

1. A method of delivering leak detection dye into an air conditioning unit having a fitting for receiving fluids, the method comprising the steps of:
connecting a source of refrigerant to a first inlet port of a manifold, a source of dye to a second inlet port of the manifold, and a first outlet port of the manifold to the fitting;
preventing the refrigerant from exiting the outlet port while delivering a quantity of dye from the source of supply through the first inlet port, the outlet port and the fitting to the unit; and
preventing the dye from exiting the outlet port while delivering a quantity of refrigerant from the source of refrigerant through the second inlet port and the outlet port to the unit.

2. The method of claim 1, wherein the manifold has a third inlet port and the step of connecting further comprises connecting a source of vacuum pressure to the third inlet port, and prior to the step of delivering the dye, the vacuum source applies a vacuum to the air conditioning unit through the outlet port.

3. The method of claim 2, wherein the vacuum source is fluidly disconnected from the air conditioning unit prior to delivery of the dye.

4. The method of claim 3, wherein a vacuum remains in the air conditioning unit after fluid disconnection of the vacuum source.

5. The method of claim 2, wherein the fitting has a valve that is opened for fluid delivery by depressing a pin, the manifold has a fourth inlet port, and the step of connecting further comprises connecting a stem air source of pressurized air to the fourth input port, and the outlet port has a stem that actuates on application of the stem air pressurized air from the fourth inlet port to depress the pin to open the valve prior to application of the vacuum by the vacuum source, delivery of the dye and delivery of the refrigerant.

6. The method of claim 5, wherein the manifold has a fifth inlet port and a seal mechanism that actuates on application of pressurized air, and the step of connecting further comprises connecting a seal pressure source of pressurized air to the fifth inlet port, placing the sealing mechanism about the fitting, and prior to actuating the stem actuating the sealing mechanism by applying seal pressure pressurized air through the fifth inlet port to clamp and seal the manifold to the fitting about the outlet port.

7. The method of claim 6, wherein the manifold has a control valve to open and close fluid connection between the first inlet port and the outlet port, the control valve is actuated through the application and removal of pressurized air, and the step of connecting further comprises connecting a sixth inlet port to a selection source of pressurized air.

8. The method of claim 6, wherein the manifold has a plurality of valves to permit and prevent fluid connection between the first, second and third inlet ports and the outlet port.

9. A method for use in the delivery of refrigerant and leak detection dye to an air conditioning unit, the method comprising the steps of evacuating the unit, then delivering the leak detection dye to the evacuated unit from a first source through a delivery mechanism connected to the unit and then delivering refrigerant from a second source separate from the first source to the evacuated air conditioning unit through the same delivery mechanism without removing the delivery mechanism from the air conditioning unit between the delivery of the dye and the delivery of the refrigerant.

10. A method for use in the delivery of refrigerant and leak detection dye to an air conditioning unit, the method comprising the steps of evacuating the unit, then delivering the leak detection dye to the evacuated unit from a first source through a delivery mechanism connected to the unit and then delivering refrigerant from a second source not inline with the first source to the evacuated air conditioning unit through the same delivery mechanism without removing the delivery mechanism from the air conditioning unit between the delivery of the dye and the delivery of the refrigerant.

11. A method for use in the delivery of leak detection dye to an air conditioning unit, the method comprising the steps of evacuating the unit, then delivering the leak detection dye to the evacuated unit from a first source through a delivery mechanism connected to a fitting of the unit and then washing dye from fitting and the delivery mechanism by delivering refrigerant from a second source separate from the first source to the evacuated air conditioning unit through the same delivery mechanism without removing the delivery mechanism from the fitting between the delivery of the dye and the delivery of the refrigerant.

12. The method of claim 11, wherein the step of washing the delivery mechanism comprises washing all areas of the delivery mechanism that come into contact with dye during delivery and are open to the atmosphere when the delivery mechanism is removed from the fitting.

13. A method for use in the delivery of leak detection dye to an air conditioning unit, the method comprising the steps of first evacuating the unit, and then delivering the dye to the evacuated unit from a first source through a delivery mechanism connected to the unit and refrigerant from a second source separate from the first source to the evacuated air conditioning unit through the same delivery mechanism.

14. The method of claim 9 wherein the first source has a multiuse capacity.

15. The method of claim 10 wherein the first source has multiuse capacity.

16. The method of claim 11 wherein the first source has a multiuse capacity.

17. The method of claim 14, wherein the multiuse capacity is sufficient for at least a plant shift.

18. A method of delivering refrigerant and dye to an air conditioning unit having a fitting, the method comprising the steps of:
First delivering the dye from one source, and subsequently delivering the dye from another source, both dye and refrigerant being delivered through the fitting without removal between the delivery of the dye and the delivery of the refrigerant of any delivery mechanism connected to the fitting.

19. The method of claim 18, further comprising the step of:
Evacuating the air conditioning unit prior to delivery of the dye and refrigerant.

20. The method of claim 18, wherein the step of delivering dye from one source comprises pumping the dye from a multiuse dye reservoir.

21. The method of claim 18, wherein the step of delivering dye from one source comprises pumping the dye from a dye reservoir sufficient for at least a plant shift.

22. The method of claim 18, wherein the step of delivering dye from one source comprises pumping the dye from a manually carriable dye reservoir.

23. The method of claim 18, wherein the step of delivering dye from one source comprises pumping the dye from a dye reservoir.

24. The method of claim 19, further comprising the steps of:
Opening any one way valve in the fitting prior to evacuating the system and delivering the dye and refrigerant; and
Closing the one-way valve following delivery of the refrigerant.

25. The method of claim 24, further comprising the steps of:
Removably connecting the delivery mechanism to the fitting prior to opening the one-way valve in the fitting; and
Disconnecting the delivery mechanism from the fitting after the one-way valve is closed.

26. The method of claim 24, wherein the step of opening the one-way valve comprises extending a stem into the fitting from the delivery mechanism; and the step of closing the one-way valve comprises retracting the stem from the fitting.

27. The method of claim 25, wherein the step of removably connecting the delivery mechanism comprises sealing the delivery mechanism about the fitting; and disconnecting the delivery mechanism comprises unsealing the delivery mechanism from the fitting.

28. The method of claim 1, wherein the method is carried out without operator intervention.

29. The method of claim 9, wherein the method is carried out without operator intervention.

30. The method of claim 10, wherein the method is carried out without operator intervention.

31. The method of claim 11, wherein the method is carried out without operator intervention.

32. The method of claim 13, wherein the method is carried out without operator intervention.

33. The method of claim 18, wherein the method is carried out without operator intervention.

34. The method of claim 1, wherein the step of delivering the dye to the unit further comprises metering the amount of dye prior to the dye entering the unit.

35. The method of claim 9, wherein the step of delivering the dye to the unit further comprises metering the amount of dye prior to the dye entering the unit.

36. The method of claim 10, wherein the step of delivering the dye to the unit further comprises metering the amount of dye prior to the dye entering the unit.

37. The method of claim 11, wherein the step of delivering the dye to the unit further comprises metering the amount of dye prior to the dye entering the unit.

38. The method of claim 13, wherein the step of delivering the dye to the unit further comprises metering the amount of dye prior to the dye entering the unit.

39. The method of claim 18, wherein the step of delivering the dye to the unit further comprises metering the amount of dye prior to the dye entering the unit.

40. The method of claim 1, wherein the dye is a liquid dye.

41. The method of claim 9, wherein the dye is a liquid dye.

42. The method of claim 10, wherein the dye is a liquid dye.

43. The method of claim 11, wherein the dye is a liquid dye.

44. The method of claim 13, wherein the dye is a liquid dye.

45. The method of claim 18, wherein the dye is a liquid dye.

46. The method of claim 1, wherein the dye is a slurry dye.

47. The method of claim 9, wherein the dye is a slurry dye.

48. The method of claim 10, wherein the dye is a slurry dye.

49. The method of claim 11, wherein the dye is a slurry dye.

50. The method of claim 13, wherein the dye is a slurry dye.

51. The method of claim 18, wherein the dye is a slurry dye.

52. The method of claim 1, wherein the dye is a powder dye.

53. The method of claim 9, wherein the dye is a powder dye.

54. The method of claim 10, wherein the dye is a powder dye.

55. The method of claim 11, wherein the dye is a powder dye.

56. The method of claim 13, wherein the dye is a powder dye.

57. The method of claim 18, wherein the dye is a powder dye.

58. The method of claim 1, wherein the dye is a tablet dye.

59. The method of claim 9, wherein the dye is a tablet dye.

60. The method of claim 10, wherein the dye is a tablet dye.

61. The method of claim 11, wherein the dye is a tablet dye.

62. The method of claim 13, wherein the dye is a tablet dye.

63. The method of claim 18, wherein the dye is a tablet dye.

64. The method of claim 1, wherein the dye is a powder dye is dissolved in refrigerant as part of the delivery step and prior to entering the air conditioning unit.

65. The method of claim 9, wherein the dye is a powder dye is dissolved in refrigerant as part of the delivery step and prior to entering the air conditioning unit.

66. The method of claim 10, wherein the dye is a powder dye is dissolved in refrigerant as part of the delivery step and prior to entering the air conditioning unit.

67. The method of claim 11, wherein the dye is a powder dye is dissolved in refrigerant as part of the delivery step and prior to entering the air conditioning unit.

68. The method of claim 13, wherein the dye is a powder dye is dissolved in refrigerant as part of the delivery step and prior to entering the air conditioning unit.

69. The method of claim 18, wherein the dye is a powder dye is dissolved in refrigerant as part of the delivery step and prior to entering the air conditioning unit.

70. The method of claim 1, wherein the dye is a tablet dye is dissolved in refrigerant as part of the delivery step and prior to entering the air conditioning unit.

71. The method of claim 9, wherein the dye is a tablet dye is dissolved in refrigerant as part of the delivery step and prior to entering the air conditioning unit.

72. The method of claim 10, wherein the dye is a tablet dye is dissolved in refrigerant as part of the delivery step and prior to entering the air conditioning unit.

73. The method of claim 11, wherein the dye is a tablet dye is dissolved in refrigerant as part of the delivery step and prior to entering the air conditioning unit.

74. The method of claim 13, wherein the dye is a tablet dye is dissolved in refrigerant as part of the delivery step and prior to entering the air conditioning unit.

75. The method of claim 18, wherein the dye is a tablet dye dissolved in refrigerant as part of the delivery step and prior to entering the air conditioning unit.

76. The method of claim 1, wherein the dye is carried on a substrate dissolved in refrigerant as part of the delivery step and prior to entering the air conditioning unit.

77. The method of claim 9, wherein the dye is carried on a substrate dissolved in refrigerant as part of the delivery step and prior to entering the air conditioning unit.

78. The method of claim 10, wherein the dye is carried on a substrate dissolved in refrigerant as part of the delivery step and prior to entering the air conditioning unit.

79. The method of claim 11, wherein the dye is carried on a substrate dissolved in refrigerant as part of the delivery step and prior to entering the air conditioning unit.

80. The method of claim 13, wherein the dye is carried on a substrate dissolved in refrigerant as part of the delivery step and prior to entering the air conditioning unit.

81. The method of claim 18, wherein the dye is carried on a substrate dissolved in refrigerant as part of the delivery step and prior to entering the air conditioning unit.

82. The method of claim 1, wherein the step of delivering the dye to the unit further comprises metering the amount of dye prior to the dye entering the unit by filling a chamber of known quantity prior to the dye entering the unit.

83. The method of claim 9, wherein the step of delivering the dye to the unit further comprises metering the amount of dye prior to the dye entering the unit by filling a chamber of known quantity prior to the dye entering the unit.

84. The method of claim 10, wherein the step of delivering the dye to the unit further comprises metering the amount of dye prior to the dye entering the unit by filling a chamber of known quantity prior to the dye entering the unit.

85. The method of claim 11, wherein the step of delivering the dye to the unit further comprises metering the amount of dye prior to the dye entering the unit by filling a chamber of known quantity prior to the dye entering the unit.

86. The method of claim 13, wherein the step of delivering the dye to the unit further comprises metering the amount of dye prior to the dye entering the unit by filling a chamber of known quantity prior to the dye entering the unit.

87. The method of claim 18, wherein the step of delivering the dye to the unit further comprises metering the amount of dye prior to the dye entering the unit by filling a chamber of known quantity prior to the dye entering the unit.

88. The method of claim 83, wherein the chamber is evacuated prior to filling the chamber with dye.

89. The method of claim 84, wherein the chamber is evacuated prior to filling the chamber with dye.

90. The method of claim 85, wherein the chamber is evacuated prior to filling the chamber with dye.

91. The method of claim 86, wherein the chamber is evacuated prior to filling the chamber with dye.

92. The method of claim 87, wherein the chamber is evacuated prior to filling the chamber with dye.

93. The method of claim 83, wherein the step of delivering dye further comprises propelling the dye from the chamber into the unit using the refrigerant.

94. The method of claim 84, wherein the step of delivering dye further comprises propelling the dye from the chamber into the unit using the refrigerant.

95. The method of claim 85, wherein the step of delivering dye further comprises propelling the dye from the chamber into the unit using the refrigerant.

96. The method of claim 86, wherein the step of delivering dye further comprises propelling the dye from the chamber into the unit using the refrigerant.

97. The method of claim 87, wherein the step of delivering dye further comprises propelling the dye from the chamber into the unit using the refrigerant.

98. A manifold for use in the delivery of liquid leak detection dye to an air conditioning unit, the manifold comprising:
An inlet port for fluid connection to a refrigerant source,
An inlet port for fluid connection to a dye source separate from the refrigerant source, and
An outlet port for the delivery of the dye and refrigerant from the manifold.

99. The manifold of claim 98, further comprising: an inlet port for connection to a vacuum source, and a select control port for opening and closing a fluid connection between the vacuum source and the outlet port.

100. The manifold of claim 98, further comprising a chamber connected to the inlet port for fluid connection to the dye source, the chamber for metering the dye from the dye source as the dye is delivered through the manifold.

101. The manifold of claim 100, wherein the chamber is also connected to the inlet port for fluid connection to the refrigerant source for propelling the dye from the chamber to the outlet port using refrigerant.

102. The manifold of claim 100, wherein the chamber is also connected to the inlet port for fluid connection to the refrigerant source for propelling the dye from the chamber to the outlet port using refrigerant, further comprising a first valve inline between the inlet port for fluid connection to a dye source and the chamber, a second valve inline between the inlet port for fluid connection to a refrigerant source and the chamber, and a third valve inline between the outlet port and the chamber and inlet ports.

103. The manifold of claim 100, wherein the chamber is also connected to the inlet port for fluid connection to the refrigerant source for propelling the dye from the chamber to the outlet port using refrigerant, further comprising a first valve inline between the inlet port for fluid connection to a dye source and the chamber, a second valve inline between the inlet port for fluid connection to a refrigerant source and the chamber, and a third valve inline between the outlet port and the chamber and inlet ports, wherein the first valve opens when dye is delivered into the manifold while the second and third valves are closed, the first valve closes when the chamber is full of dye, the second and third valves open when refrigerant is delivered to the manifold.

104. The manifold of claim 100, wherein the chamber is also connected to the inlet port for fluid connection to the refrigerant source for propelling the dye from the chamber to the outlet port using refrigerant, further comprising a first valve inline between the inlet port for fluid connection to a dye source and the chamber, a second valve inline between the inlet port for fluid connection to a refrigerant source and the chamber, and a third valve inline between the outlet port and the chamber and inlet ports, wherein the first valve opens when dye is delivered into the manifold while the second and third valves are closed, the first valve closes when the chamber is full of dye, the second and third valves open when refrigerant is delivered to the manifold, further comprising a chamber connected to the inlet port for fluid connection to the dye source, the chamber for metering the dye from the dye source as the dye is delivered through the manifold, wherein the chamber is connected to the inlet port for connection to a vacuum source.

105. The manifold of claim 100, wherein the chamber is also connected to the inlet port for fluid connection to the refrigerant source for propelling the dye from the chamber to the outlet port using refrigerant, further comprising a first valve inline between the inlet port for fluid connection to a dye source and the chamber, a second valve inline between the inlet port for fluid connection to a refrigerant source and the chamber, and a third valve inline between the outlet port and the chamber and inlet ports, wherein the first valve opens when dye is delivered into the manifold while the second and third valves are closed, the first valve closes when the chamber is full of dye, the second and third valves open when refrigerant is delivered to the manifold, further comprising a chamber connected to the inlet port for fluid connection to the dye source, the chamber for metering the dye from the dye source as the dye is delivered through the manifold, wherein the chamber is connected to the inlet port for connection to a vacuum source, wherein the select control port opens and closes fluid connection between the vacuum source and the chamber.

106. The manifold of claim 100, wherein the chamber is also connected to the inlet port for fluid connection to the refrigerant source for propelling the dye from the chamber to the outlet port using refrigerant, further comprising a first valve inline between the inlet port for fluid connection to a dye source and the chamber, a second valve inline between the inlet port for fluid connection to a refrigerant source and the chamber, and a third valve inline between the outlet port and the chamber and inlet ports, and a fourth valve inline between the vacuum source and the chamber and outlet port.

107. The manifold of claim 100, wherein the chamber is also connected to the inlet port for fluid connection to the refrigerant source for propelling the dye from the chamber to the outlet port using refrigerant, further comprising a first valve inline between the inlet port for fluid connection to a dye source and the chamber, a second valve inline between the inlet port for fluid connection to a refrigerant source and the chamber, and a third valve inline between the outlet port and the chamber and inlet ports, and a fourth valve inline between the vacuum source and the chamber and outlet port, wherein the fourth valve and the third valve open when the select control port opens the fluid connection at the outlet port, while the first and second valves are closed, and wherein the first valve opens when dye is delivered into the manifold while the second and third valves are closed, the first valve closes when the chamber is full of dye, the second and third valves open when refrigerant is delivered to the manifold.

108. The manifold of claim 98, further comprising valves to prevent fluid connection between the inlet port of the refrigerant and the inlet port of the dye.

109. The manifold of claim 99, further comprising valves to prevent fluid connection between the inlet port for the refrigerant, the inlet port for the dye and the inlet port for the vacuum.

110. The manifold of claim 98 wherein the manifold is an integrated unit.

111. The manifold of claim 99 wherein the manifold is an integrated unit.

112. The manifold of claim 109 wherein the manifold is an integrated unit.

113. A system for the delivery of liquid leak detection dye to an air conditioning unit, the system comprising:
a refrigerant source,
a dye source separate from the refrigerant source,
a manifold including:
an inlet port for fluid connection to a refrigerant source,
an inlet port for fluid connection to a dye source separate from the refrigerant source, and
an outlet port for the delivery of the dye and refrigerant from the manifold,
and a control unit for activating the dye source to deliver dye to the outlet port and then activating the refrigerant source to deliver dye to the outlet port.

114. The system of claim 113, further comprising:
a vacuum source;
wherein, the control unit fluidly connects the vacuum source to the outlet prior to delivery of the dye and refrigerant to create a vacuum into which the dye and refrigerant are delivered.

115. The system of claim 114, further comprising a select source and wherein the manifold further includes a control port for receiving the select source and the manifold fluidly connects and disconnects the vacuum source from the outlet depending on whether the select source is activated or deactivated, and the select source is activated and deactivated by the control unit.

116. The system of claim 115, further comprising a seal source and wherein the outlet port further comprises a seal mechanism that seals the outlet port to and releases the outlet port from the air conditioning unit depending on whether or not the seal source is activated or deactivated, and the seal source is activated or deactivated by the control unit.

117. The system of claim 113, wherein the dye source comprises a dye reservoir for containing multiuse quantity of dye.

118. The system of claim 113, wherein the dye source comprises a manually carriable dye reservoir for containing dye.

119. The system of claim 113, wherein the dye source further comprises a first pressurizing pump to deliver the dye from the dye reservoir to the outlet port.

120. The system of claim 117, wherein the dye reservoir has sufficient capacity for at least a plant shift.

121. The system of claim 117, wherein the refrigerant source comprises a bulk refrigerant reservoir for containing refrigerant.

122. The system of claim 117, wherein the refrigerant source further comprises a second pressurizing pump to deliver the refrigerant from the refrigerant reservoir to the outlet port.

123. A system for the delivery of liquid leak detection dye to an air conditioning unit, the system comprising:
a refrigerant source having a refrigerant reservoir,
a dye source having a refrigerant reservoir separate from the refrigerant source,
a manifold including:
an inlet port for fluid connection to a refrigerant source,
an inlet port for fluid connection to a dye source separate from the refrigerant source,
an outlet port for the delivery of the dye and refrigerant from the manifold,
and a control unit for activating the dye source to deliver dye to the outlet port and activating the refrigerant source to deliver dye to the outlet port.
